(19) United States
(12) Patent Application Publication
(10) Pub. No.: US 2026/0292327 A1
(43) Pub. Date: Sep. 24, 2026

(54) IMAGE DATA PROCESSING METHOD, DEVICE, AND STORAGE MEDIUM

(71) Applicant: Beijing Zitiao Network Technology Co., Ltd., Beijing (CN)

(72) Inventors: Zihao CHEN, Beijing (CN); Qiming Wang, Beijing (CN)

(21) Appl. No.: 19/432,808

(22) Filed: Dec. 24, 2025

(30) Foreign Application Priority Data
Mar. 24, 2025 (CN) 202510355024.7

(51) Int. Cl. H04N 23/63

(52) U.S. Cl. CPC H04N 23/632

(57) ABSTRACT

The present disclosure provide an image data processing method, a device and a storage medium. The method includes: acquiring a first video, where the first video includes multi-frame images, and the first video is a slow-motion video; dividing the first video into a first video subset and a second video subset; performing frame dropping on the first video subset; applying an effect on the first video subset in which frame dropping is performed, and recording effect application information of the effect; previewing and displaying the first video subset in which the effect is applied; and generating an asset pack including the second video subset and the effect application information.

### CROSS-REFERENCE TO RELATED APPLICATION

This application claims the priority to and benefits of the Chinese Patent Application, No. 202510355024.7, which was filed on Mar. 24, 2025. The aforementioned patent application is hereby incorporated by reference in its entirety.

### TECHNICAL FIELD

One or more embodiments of the present disclosure relate to the field of computer and image data processing, and in particular, to an image data processing method, a device, and a storage medium.

### BACKGROUND

In many application scenarios, slow-motion videos are required. For example, in a scenario where movement details need to be analyzed or in a scenario where a visual effect needs to be enhanced, a slow-motion video may be produced and displayed.

In order to further improve the visual effect, there is a need to apply an effect to the slow-motion video. However, due to a large resource occupancy, it is impossible to preview an effect application result when an effect is applied to a slow-motion video to generate an asset pack.

### SUMMARY

One or more embodiments of the present disclosure provide an image data processing method, a device, a readable storage medium and a program product to overcome the problem that it is impossible to preview an effect application result when an effect is applied to a slow-motion video to generate a asset pack due to a large resource occupancy.

At least an embodiment of the present disclosure provides an image data processing method, including:
acquiring a first video, where the first video includes multi-frame images, and the first video is a slow-motion video;
dividing the first video into a first video subset and a second video subset;
performing frame dropping on the first video subset;
applying an effect on the first video subset in which frame dropping is performed, and recording effect application information of the effect;
previewing and displaying the first video subset in which the effect is applied; and
generating an asset pack including the second video subset and the effect application information.

At least an embodiment of the present disclosure provides an image data processing device, including:
an acquiring unit, configured to acquire a first video, where the first video includes multi-frame images, and the first video is a slow-motion video;
a dividing unit, configured to divide the first video into a first video subset and a second video subset;
a frame dropping unit, configured to perform frame dropping on the first video subset;
an effect applying unit, configured to apply an effect on the first video subset in which frame dropping is performed, and record effect application information of the effect;
a displaying unit, configured to preview and display the first video subset in which the effect is applied; and
a generating unit, configured to generate an asset pack including the second video subset and the effect application information.

At least an embodiment of the present disclosure provides an electronic device, including: a processor and a memory;
the memory stores a computer-executed instruction; and
the processor executes the computer-executed instruction stored in the memory, causing the at least one processor to execute the image data processing method according to the foregoing embodiments.

At least an embodiment of the present disclosure provides a non-transitory computer-readable storage medium, which is stored with computer-executed instructions, where the computer-executed instructions, when executed by a processor, cause the processor to perform the image data processing method according to the foregoing embodiments.

At least an embodiment of the present disclosure provides a computer program product, including a computer program, where the computer program, when executed by a processor, cause the processor to perform the image data processing method according to the foregoing embodiments.

### BRIEF DESCRIPTION OF DRAWINGS

In order to more clearly explain the technical solutions in one or more embodiments of the present disclosure or in the prior art, the drawings required in describing the embodiments or the prior art will be briefly introduced below. Obviously, the drawings in the following description are some embodiments of the present disclosure, and for those skilled in the art, other drawings may also be obtained from these drawings without paying creative labor.

FIG. 1 is a first schematic flowchart of an image data processing method provided by at least an embodiment of the present disclosure;

FIG. 2 is a second schematic flowchart of an image data processing method provided by at least an embodiment of the present disclosure;

FIG. 3 is a structural block diagram of an image data processing apparatus provided by at least an embodiment of the present disclosure; and

FIG. 4 is a schematic hardware structural diagram of an electronic device provided by at least an embodiment of the present disclosure.

### DETAILED DESCRIPTION

In order to make objectives, technical solutions and advantages of embodiments of the present disclosure clearer, the technical solutions in one or more embodiments of the present disclosure will be described clearly and comprehensively with reference to the drawings in one or more embodiments of the present disclosure. Obviously, the described embodiments are part of one or more embodiments of the present disclosure, rather than all of them. Based on the embodiments in the present disclosure, all other embodiments obtained by those skilled in the art without paying creative labor belong to the protection scope of the present disclosure.

A slow-motion video (also known as a slow-motion shot or a slow-motion video) refers to a technology that slows down a video playback speed by technical means to show an action process in more detail than a normal speed. The slow-motion video usually uses an image acquisition frame rate higher than a normal playback frame rate to acquire an image sequence, and then plays the acquired image sequence at a normal playback frame rate, thereby achieving an effect of slowing down time. For example, assuming that a video is shot at a frequency of 240 frames per second, when the shot video is played at a playback frame rate of 30 frames per second, an effect of 8× slow-motion video may be achieved.

In some application scenarios, a user may apply an effect to a slow-motion video, and expects to preview a display effect of the effect applied to the slow-motion video while adding the effect. However, since data volume of the slow-motion video is relatively large, if the effect is applied frame by frame in the slow-motion video and previewed and displayed, it will occupy more resources of a system, and usually it is impossible to simultaneously display an effect of the slow-motion video in which the effect is applied and generate an asset pack including the slow-motion video in which the effect is applied.

According to the solution provided by the present disclosure, a slow-motion video is split, an effect is applied for previewing after frame dropping is performed on one way of video subset obtained by splitting, and an asset pack is generated according to another way of video subset obtained by splitting and effect application information, thereby reducing resources required for previewing and displaying after the effect is applied to the slow-motion video and resources required for generating a slow-motion video asset pack in which the effect is applied. Therefore, the problem that it is impossible to simultaneously display an effect of a slow-motion video in which an effect is applied and generate an asset pack including the slow-motion video in which the effect is applied may be solved.

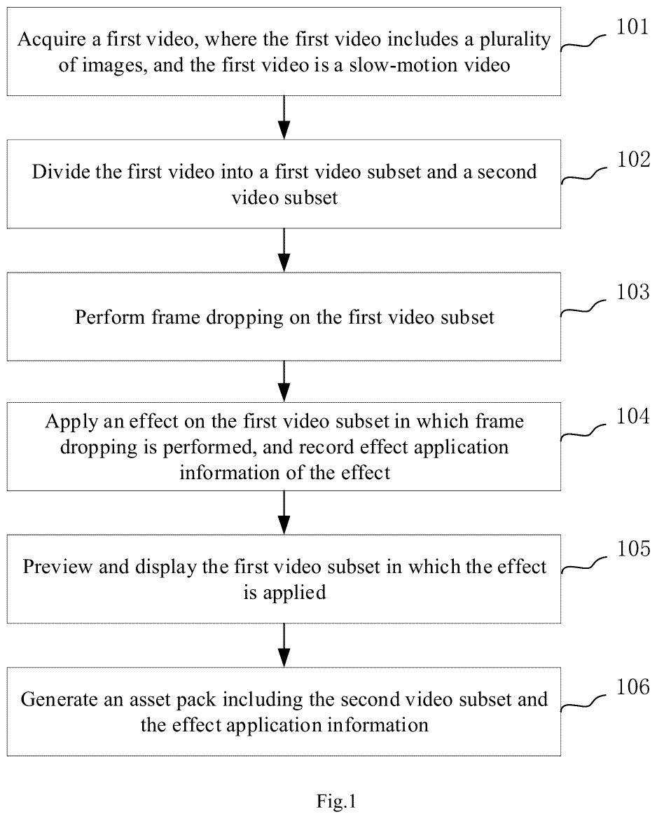

Referring to FIG. 1, FIG. 1 shows a first schematic flowchart of an image data processing method provided by the present disclosure. As shown in FIG. 1, the method includes the following steps.

S101: acquiring a first video, where the first video includes a plurality of images, and the first video is a slow-motion video.

An execution body of the image data processing method in the present embodiment may be a terminal device, and specifically may be an application running in the terminal device. In some application scenarios, the application may be an application for calling an image acquisition apparatus to perform acquisition and editing an image.

The first video may be acquired in advance by other image acquisition apparatus using a relatively high frame rate (for example, 120 frames per second, 240 frames per second). The first video may include a plurality of images arranged in sequence according to acquisition time.

In some application scenarios, the first video may also be a video acquired in real time using an image acquisition apparatus on the terminal device.

In these application scenarios, a user may initiate a slow-motion video acquisition instruction on the terminal device, for example, may perform a triggering operation on a preset slow-motion video recording control in a display interface of the application.

The image acquisition apparatus may continuously acquire multi-frame images according to an image acquisition frame rate higher than a display frame rate according to the slow-motion video acquisition instruction. The multi-frame images continuously acquired form the first video. The image acquisition frame rate may be, for example, 120 frames per second, 240 frames per second, etc.

S102: dividing the first video into a first video subset and a second video subset.

In an example, the execution body may shunt the first video into the first video subset and the second video subset. Specifically, the first video may be copied or distributed into two independent video subsets, that is, after each frame of image is received, a copy of the frame is created and sent to two different processing paths respectively. One of the video subsets may be regarded as the first video subset, and the other video subset may be regarded as the second video subset.

S103: performing frame dropping on the first video subset.

Frame dropping may be performed on the first video subset. For example, frame dropping is performed on the first video subset according to a preview display frame rate. Specifically, a frame dropping strategy may be determined according to an image acquisition frame rate of the first video and the preview display frame rate, and an image frame in the first video subset is droppeddropped according to the frame dropping strategy.

Illustratively, assuming that the image acquisition frame rate is 240 frames per second and the preview display frame rate is 30 frames per second, one frame may be retained every 8 frames in the first video subset, and the remaining 7 frames are droppeddropped. After frame dropping is performed on the first video subset according to the frame dropping strategy, the first video subset in which the frame dropping is performed may be obtained.

An effect is applied on the first video subset in which frame dropping is performed. The effect here may include one or more types of effects, and the number of effects included in each type of effect may include more than one. The effects may include, for example, beautification, stickers, audio, etc.

After the effect is applied on each image frame in the first video subset in which frame dropping is performed, the first video subset in which the effect is applied may be sent to a displaying unit for previewing and displaying.

S104: applying an effect on the first video subset in which the frame dropping is performed, and recording effect application information of the effect.

S105: previewing and displaying the first video subset in which the effect is applied.

When processing an image sequence acquired at a high image acquisition frame rate (such as 240 frames per second), if each frame of image requires complex image processing operations (such as effect processing such as beautification), due to limitations of computing resources and time, a system may not be able to complete processing of all frames within a specified time, resulting in frame backlog. As time goes by, this backlog will lead to an increasing processing delay, and finally the output image will seriously lag behind an actual event. If a slow-motion video is also being acquired at the same time, images may not be acquired according to an image acquisition frame rate corresponding to the slow-motion video due to resource occupancy.

The effect is applied after frame dropping is performed on the first video subset, thereby reducing the number of image frames on which the effect needs to be applied, that is, reducing resource occupancy required for previewing video content in which the effect is applied, and the first video subset in which the effect is applied may be previewed and displayed more smoothly.

It may be understood that each image in the first video has its own timestamp, where a timestamp corresponding to a first frame is 00:00:00. The timestamp corresponding to each image may correspond to, for example, start display time.

When the effect is applied on the first video subset in which frame dropping is performed, the effect application information of the first video subset is recorded. The effect information may include an effect identification (or effect data) and an effect application setting of at least one effect applied, for example, which effects are used in multiple time periods of the first video subset, etc, for another example, among a plurality of effects applied on the first video subset, start application time and end application time of each effect, etc.

S106: generating an asset pack including the second video subset and the effect application information.

For the second video subset, in order to save resources, when the asset pack is generated, the effect is not applied on the second video subset, instead, the asset pack is generated according to multiple original images in the second video subset, and the recorded effect application information is encapsulated in the asset pack as metadata.

The asset pack usually refers to a collection of various resources for creation or design. These resource collections may include multimedia elements such as images, audio, video, 3D models, fonts, icons, etc. The asset pack may provide ready-made design elements and multimedia resources, enabling creators to quickly find required materials, thereby saving time for creating these elements from scratch. Creation efficiency may be improved.

When a video file is played, the effect application information in the video file may be read, and the effect is applied on the second video subset according to the effect application setting in the effect application information.

In the present embodiment, a first video is acquired, where the first video includes a plurality of images, and the first video is a slow-motion video; the first video is divided into a first video subset and a second video subset; frame dropping is performed on the first video subset; an effect is applied on the first video subset in which frame dropping is performed, and effect application information of the effect is recorded; the first video subset in which the effect is applied is previewed and displayed; and an asset pack including the second video subset and the effect application information is generated. Since frame dropping is performed in advance on the first video subset for previewing to reduce the number of images on which the effect needs to be applied, resources occupied for previewing are reduced. At the same time, the asset pack is generated according to original images in the second video subset, and the effect application information is encapsulated in the asset pack, thereby reducing resources required for generating a slow-motion video asset pack in which the effect is applied. Therefore, smooth previewing after the effect is applied to the slow-motion video and production of the slow-motion video asset pack in which the effect is applied may be achieved at the same time. The effect application information in the asset pack is used for displaying the slow-motion video in which the effect is applied when a video file is subsequently opened.

In some embodiments, applying the effect after frame dropping is performed on the first video subset in step S103 includes the following steps.

Firstly, a frame dropping strategy is determined according to a preview display frame rate and an image acquisition frame rate corresponding to the first video.

Secondly, frame dropping is performed on the first video subset according to the frame dropping strategy.

Finally, the effect is applied on the first video subset in which frame dropping is performed.

In some examples, the preset display frame rate may be set by a user, and in some other examples, the preset display frame rate may be automatically set by a system of the terminal device. The preset display frame rate may be 3 frames per second, 60 frames per second, etc.

The image acquisition frame rate may be higher than a normal display frame rate of the terminal device, and the image acquisition frame rate is, for example, 120 frames per second, 240 frames per second. The frame dropping strategies include but not limited to: fixed interval frame dropping, time-based frame dropping, content-based frame dropping, etc.

The fixed interval frame dropping may be performed according to a fixed frame interval. Taking an image acquisition frame rate of 120 frames per second and a display frame rate of 30 frames per second as an example, one frame of image is dropped every 4 frames of images, which may ensure that an interval between remaining frames is relatively uniform, and helps to maintain basic fluency of a preview image.

The time-based frame dropping may be performed according to a set time interval, for example, only 30 frames are retained per second, and the remaining frames are dropped.

The content-based frame dropping is to decide which frames to be dropped by analyzing content of an image frame. For example, if a change between two frames is very small, a latter frame may be selected to be dropped. This frame dropping strategy may balance quality and data volume of the preview image.

It may be understood that different frame dropping strategies may also be combined to perform frame dropping on the first video subset.

By performing frame dropping on the first video subset according to the frame dropping strategy, the first video subset in which frame dropping is performed may be obtained. After that, the execution body may apply an effect on each image retained in the first video subset in which frame dropping is performed. A frame dropping strategy is determined according to a preview display frame rate and an image acquisition frame rate of an image acquisition apparatus, and frame dropping is performed on a first video subset according to the frame dropping strategy, thereby reducing resources required for previewing and achieving fluency of a preview image.

In some embodiments, step S103 includes:
according to a preset effect application strategy for applying a plurality of effects, applying a corresponding one of effects on each of the images in the first video subset in which frame dropping is performed, where effects applied on the images are the same or different according to the preset effect application strategy.

In an example, according to the preset effect strategy, the same effect may be applied on multi-frame images.

In another example, according to the preset application strategy of a plurality of effects, for example, different effects may be applied on multi-frame images, including an effect switching strategy, a combination strategy of different effects, etc.

The effect switching strategy may include, for example, switching effects according to a time interval, switching effects according to image content, etc. The switching effects according to the time interval may include automatically changing an effect every N seconds, where N may be any value greater than 0.

The content-based effect selection includes determining effects corresponding to each frame of image respectively by parsing content of each frame of image (for example, object detection, face recognition). Specifically, target image content corresponding to each of the effects may be preset. For any image, the execution body may detect image content in the image, identify whether the image content includes a target object, and if the target object is included, determine a target effect matching the target object, and apply the target effect on the frame of image.

In this example, effects applied on multi-frame images of the first video subset in which frame dropping is performed using the preset effect application strategy may be different.

In these embodiments, a plurality of effects are applied on the first video subset in which frame dropping is performed according to the preset effect application strategy, so that corresponding effects may be applied on respective images in the first video subset, and a visual effect of the generated video content may be improved.

In some embodiments, step S104 includes: performing compression encoding on the second video subset to generate an asset pack including a compression-encoded second video subset.

Specifically, an encoder (such as H.264/AVC, H.265/HEVC, etc.) may be selected, and then the selected encoder is used to perform compression encoding on the second video subset according to preset encoding parameters. The encoding parameters include but not limited to: resolution, group of pictures (GOP) structure, quantization parameter, preset mode, etc. The resolution includes resolution of an output video. The GOP structure includes distribution of I frames, P frames and B frames. The quantization parameter includes impact on compression quality and file size. The preset mode includes balancing encoding speed and quality. The execution body may call a video file generation tool to perform compression encoding on the second video subset, and package video data after compression encoding into a preset container (such as MP4, etc.), thereby obtaining the asset pack.

In the present embodiment, by performing compression encoding on the second video subset, redundant information between images is reduced, and an asset pack with a smaller data volume may be obtained, which is beneficial to storage and transmission of the asset pack.

In some embodiments, step S104 further includes:
speed change information corresponding to the first video.

The speed change information may be, for example, slow motion times, and the slow motion times may be determined by a ratio between the image acquisition frame rate and a display frame rate. The display frame rate may also be determined according to the image acquisition frame rate and the slow motion times.

The speed change information may include, for example, 8× speed change, 4× speed change, etc. The speed change information may be set according to a specific application scenario.

In addition, when a slow-motion video is recorded, slow-motion playback times are not necessarily directly specified, and a slow-motion effect that may be achieved during subsequent playback may be indirectly determined by selecting different image acquisition frame rates.

In these embodiments, the speed change information of the slow-motion video may also be encapsulated in the asset pack, so that when a user subsequently opens the asset pack for playback, the second video subset in the asset pack may be played according to the speed change information, so as to achieve automatic slow-motion playback.

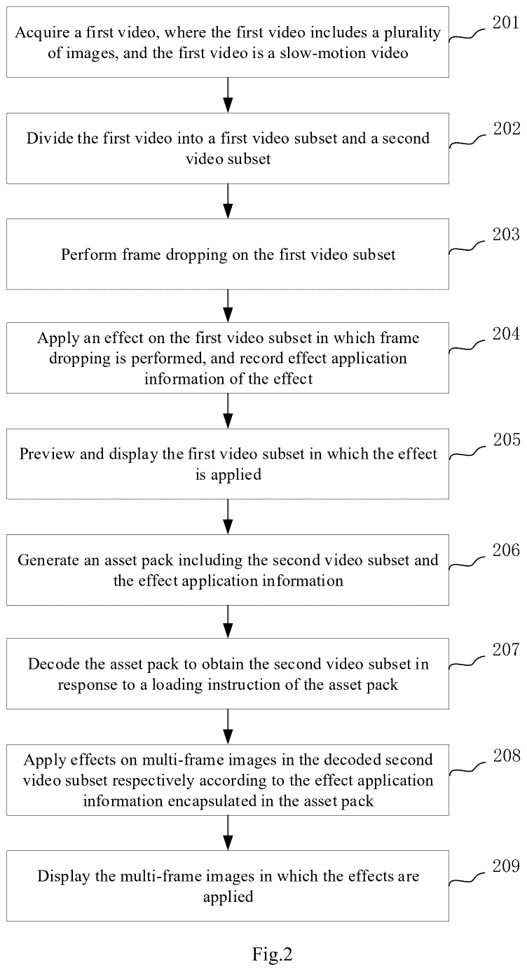

Referring to FIG. 2, FIG. 2 is a second schematic flowchart of an image data processing method provided by the present disclosure. As shown in FIG. 2, in addition to steps S201-S206 which are the same as steps S101-S106 of the embodiment shown in FIG. 1, the method further includes the following steps.

S207: decoding the asset pack to obtain the second video subset in response to a loading instruction of the asset pack.

In the present embodiment, an execution body of the image data processing method may be a terminal device used by a user, and specifically may be an application running in the terminal device and capable of processing video image data.

In some examples, an execution body of steps S205-S206 may be the same execution body as the terminal device that executes steps S201-S206, or may be a different execution body. For example, a user may obtain an asset pack through steps S201-S206 in terminal device A, then send the asset pack to terminal device B, and the asset pack may be loaded through an application in terminal device B.

In an example, the user may issue the loading instruction in the application for editing a video file running on the terminal device. For example, the user may trigger a control for loading an asset pack in the application, and select an identification of an asset pack in a file list displayed after the control is triggered, thereby issuing the loading instruction for the asset pack to the terminal device.

After receiving the loading instruction, the terminal device may decode the asset pack to obtain multi-frame images of the second video subset.

S208: applying effects on the multi-frame images in the decoded second video subset respectively according to the effect application information encapsulated in the asset pack.

In an example, the effect application information may include identifications of a plurality of effects. The effect identifications are used to distinguish different effects. In an example, a corresponding effect may be acquired from other electronic devices (such as a server) according to the effect identification. In an example, the effect information may further include effect content, and here, when the effect content is loaded and displayed, a corresponding effect may be presented.

The a plurality of effects may include different categories of effects, and the effects may include, for example, one or more of the following categories: filters, filtering effects, scaling, text and graphics, dynamic elements, beautification, masking and matting, etc.

In some implementations, the effect information includes a preset effect application strategy of applying the same effect or different effects on the multi-frame images.

In some application scenarios, the preset effect application strategy may include, for example, an effect application strategy of applying the same effect on multi-frame images.

In these application scenarios, the execution body may apply the same effect on the multi-frame images decoded from the target video file according to the preset effect application strategy, thereby obtaining the multi-frame images in which the effect is applied.

In some other application scenarios, the preset effect application strategy may further include a strategy of applying different effects on multi-frame images.

In these application scenarios, the preset effect application strategy may include, for example, switching effects according to a time interval, switching effects according to image content, etc.

According to these preset effect application strategies, different effects may be applied on the multiple frames of video images. Richness of the displayed video content may be improved, and a visual effect may be improved.

S209: displaying the multi-frame images in which the effects are applied.

The execution body may send the multi-frame images in which the effects are applied to a displaying unit, and the displaying unit may display the multi-frame images in sequence according to respective timestamps.

In the present embodiment, an asset pack including multi-frame images of a second video subset of a slow-motion video and corresponding effect application information is generated, thereby saving resources required for generating a asset pack of the slow-motion video in which an effect is applied. When the asset pack is loaded, corresponding effects are applied on respective multi-frame images decoded from the asset pack according to the effect application information encapsulated in the asset pack, so as to display the slow-motion video in which the effects are applied.

In some optional implementations of the present embodiment, step S207 includes:
displaying the multiple frames of video images according to a display frame rate corresponding to speed change information encapsulated in the asset pack.

Image attributes in the second video subset retain timestamps.

In an example, an image acquisition frame rate of the slow-motion video may be determined according to timestamps corresponding to the multi-frame images respectively. In an example, the image acquisition frame rate may be recorded in a file header of the first video, and in this example, the image acquisition frame rate may be read from the file header of the first video.

Before receiving an instruction from a user to modify speed change information, the execution body may determine the display frame rate using the speed change information encapsulated in the target video file and the image acquisition frame rate, and then may control the displaying unit to display the multiple frames of video images according to the display frame rate to show a slow-motion effect.

Illustratively, if the image acquisition frame rate is 240 frames per second and the speed change information is 8× slow motion, the display frame rate is 240/8=30 frames per second.

It may be understood that the user may adjust slow motion times when the asset pack is loaded or video content of the asset pack is displayed. If the user adjusts the slow motion times, the display frame rate may be determined according to the adjusted slow motion times, and the multi-frame images are displayed according to the display frame rate.

In these implementations, a display frame rate is determined according to speed change information encapsulated in an asset pack, and multi-frame images decoded from the asset pack are displayed according to the display frame rate, so that a slow-motion effect may be automatically shown according to the speed change information.

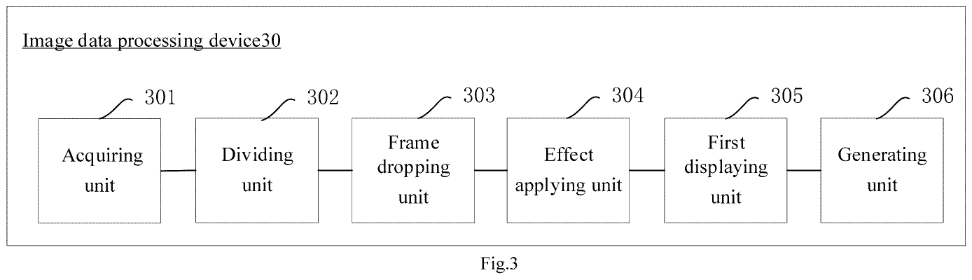

Corresponding to the image data processing method of the above embodiments, FIG. 3 is a structural block diagram of an image processing device provided by at least an embodiment of the present disclosure. For convenience of explanation, only parts related to one or more embodiments of the present disclosure are shown. Referring to FIG. 3, the apparatus 30 includes: an acquiring unit 301, a dividing unit 302, a frame dropping unit 303, an effect applying unit 304, a first displaying unit 305 and a generating unit 306.

The acquiring unit 301 is configured to acquire a first video, where the first video includes multi-frame images, and the first video is a slow-motion video;
the dividing unit 302 is configured to divide the first video into a first video subset and a second video subset;
the frame dropping unit 303 is configured to perform frame dropping on the first video subset;
the effect applying unit 304 is configured to apply an effect on the first video subset in which frame dropping is performed, and record effect application information of the effect;
the first displaying unit 305 is configured to preview and display the first video subset in which the effect is applied; and
the generating unit 306 is configured to generate an asset pack including the second video subset and the effect application information.

According to the device provided by the present embodiment, a first video is acquired by an acquiring unit, where the first video includes multi-frame images, and the first video is a slow-motion video; the first video is divided into a first video subset and a second video subset by a dividing unit; frame dropping is performed on the first video subset by a frame dropping unit; an effect is applied on the first video subset in which frame dropping is performed by an effect applying unit, and effect application information of the effect is recorded; the first video subset in which the effect is applied is previewed and displayed by a displaying unit; and a asset pack including the second video subset and the effect application information is generated by a generating unit. Since frame dropping is performed in advance on the first video subset for previewing to reduce the number of images on which the effect needs to be applied, the asset pack is produced according to original images for the video subset used to generate the asset pack, and the effect application information is encapsulated in the asset pack, resources required for previewing an effect of applying the effect on the slow-motion video and generating the slow-motion video asset pack in which the effect is applied are reduced at the same time, smooth previewing after the effect is applied to the slow-motion video and production of the slow-motion video asset pack in which the effect is applied may be achieved at the same time. The effect application information in the asset pack is used for displaying the slow-motion video in which the effect is applied when a video file is subsequently opened.

In at least an embodiment of the present disclosure, the frame dropping unit 303 is further configured to:
determine a frame dropping strategy according to a preview display frame rate and an image acquisition frame rate corresponding to the first video; and
perform frame dropping on the first video subset according to the frame dropping strategy.

In summary, furthermore, by performing frame dropping on the first video subset according to the frame dropping strategy, the first video subset in which frame dropping is performed may be obtained. After that, the execution body may apply an effect on each image retained in the first video subset in which frame dropping is performed. A frame dropping strategy is determined according to a preview display frame rate and an image acquisition frame rate of an image acquisition apparatus, and frame dropping is performed on a first video subset according to the frame dropping strategy, thereby reducing resources required for previewing and achieving fluency of a preview image.

In at least an embodiment of the present disclosure, the generating unit 306 is further configured to:
perform compression encoding on the second video subset to generate the asset pack including a compression-encoded second video subset.

In summary, furthermore, by performing compression encoding on the second video subset, redundant information between images is reduced, and an asset pack with a smaller data volume may be obtained, which is beneficial to storage and transmission of the asset pack.

In at least an embodiment of the present disclosure, the asset pack is further encapsulated with: speed change information corresponding to the first video.

In summary, furthermore, speed change information of the slow-motion video may also be encapsulated in the asset pack, so that when a user subsequently opens the asset pack for playback, the second video subset in the asset pack may be played according to the speed change information, so as to achieve automatic slow-motion playback.

In at least an embodiment of the present disclosure, the effect applying unit 304 is further configured to: according to a preset effect application strategy for applying a plurality of effects, apply corresponding effects on respective images in the first video subset in which frame dropping is performed, where effects applied on the a plurality of images are the same or different according to the preset effect application strategy.

In summary, furthermore, a plurality of effects are applied on the first video subset in which frame dropping is performed according to the preset effect application strategy, so that corresponding effects may be applied on respective images in the first video subset, and a visual effect of the generated video content may be improved.

In at least an embodiment of the present disclosure, the device 30 further includes a second displaying unit (not shown in the figure), and the second displaying unit is configured to:
decode the asset pack to obtain the second video subset in response to a loading instruction of the asset pack;
apply effects on multi-frame images in the decoded second video subset respectively according to the effect application information encapsulated in the asset pack; and
display the multi-frame images in which the effects are applied. In at least an embodiment of the present disclosure, the effect application information includes a preset effect application strategy of applying the same effect or different effects on the multiple frames of video images.

In summary, furthermore, an asset pack including multi-frame images of a second video subset of a slow-motion video and corresponding effect application information is generated, thereby saving resources required for generating the asset pack of the slow-motion video in which an effect is applied. When the asset pack is loaded, corresponding effects are applied on the multi-frame images decoded from the asset pack according to the effect application information encapsulated in the asset pack, so as to display the slow-motion video in which the effects are applied.

In at least an embodiment of the present disclosure, the first displaying unit 305 is further configured to:
display the multi-frame images according to a display frame rate corresponding to speed change information encapsulated in the asset pack.

In summary, furthermore, a display frame rate is determined according to speed change information encapsulated in a asset pack, and multi-frame images decoded from the asset pack are displayed according to the display frame rate, so that a slow-motion effect may be automatically shown according to the speed change information.

In order to achieve the above embodiments, at least an embodiment of the present disclosure further provides an electronic device.

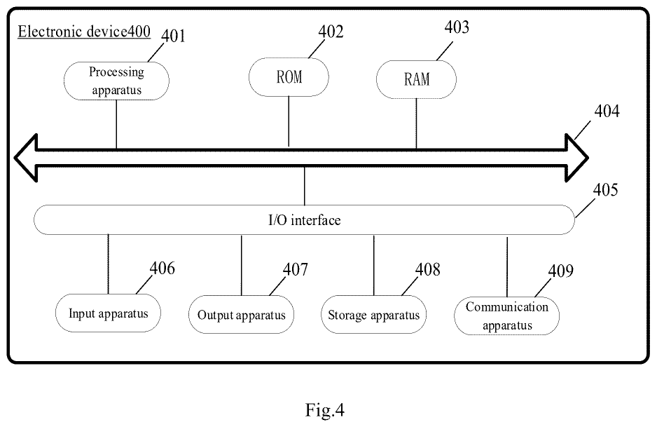

Please refer to FIG. 4, which illustrates a schematic structural diagram of an electronic device 400 suitable for implementing at least an embodiment of the present disclosure, and the electronic device 400 may be a terminal device or a server. The terminal device may include, but not limited to, mobile terminals such as a mobile phone, a notebook computer, a digital broadcasting receiver, a personal digital assistant (PDA), a tablet computer, a portable media player (PMP), a vehicle-mounted terminal (such as a vehicle-mounted navigation terminal), etc., and fixed terminals such as a digital TV, a desktop computer, etc. The electronic device shown in FIG. 4 is only an example, and should not bring any limitation to functions and application scope of the embodiments of the present disclosure.

As shown in FIG. 4, the electronic device 400 may include a processing apparatus (such as a central processing unit, a graphics processor, etc.) 401, which may perform various appropriate actions and processing according to a program stored in a read-only memory (ROM) 402 or a program loaded into a random access memory (RAM) 403 from a storage apparatus 408. In the RAM 403, various programs and data required for operations of the electronic device 400 are also stored. The processing apparatus 401, the ROM 402 and the RAM 403 are connected to each other through a bus 404. An input/output (I/O) interface 405 is also connected to the bus 404.

Usually, the following apparatuses may be connected to the I/O interface 405: an input apparatus 406 including, for example, a touch screen, a touchpad, a keyboard, a mouse, a camera, a microphone, an accelerometer, a gyroscope, etc.; an output apparatus 407 including, for example, a liquid crystal display (LCD), a speaker, a vibrator, etc.; a storage apparatus 408 including, for example, a magnetic tape, a hard disk, etc.; and a communication apparatus 409. The communication apparatus 409 may allow the electronic device 400 to perform wireless or wired communication with other devices to exchange data. Although FIG. 4 shows the electronic device 400 with various apparatuses, it should be understood that it is not required to implement or have all of the shown apparatuses. More or fewer apparatuses may be implemented or provided alternatively.

In particular, according to one or more embodiments of the present disclosure, the process described above with reference to the flowchart may be implemented as a computer software program. For example, one or more embodiments of the present disclosure include a computer program product, which includes a computer program carried on a computer-readable medium, where the computer program contains program codes for performing the method shown in the flowchart. In such an embodiment, the computer program may be downloaded and installed from a network through the communication apparatus 409, or installed from the storage apparatus 408, or installed from the ROM 402. When the computer program is executed by the processing apparatus 401, the functions defined in the method of one or more embodiments of the present disclosure are executed.

It should be noted that the computer-readable medium in one or more embodiments of the present disclosure may be a computer-readable signal medium, a computer-readable storage medium, or any combination of the above two. The computer-readable storage medium may be, for example, but not limited to, an electrical, magnetic, optical, electromagnetic, infrared, or semiconductor system, apparatus or device, or any suitable combination of the above. More specific examples of the computer-readable storage medium may include, but not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In one or more embodiments of the present disclosure, a computer-readable storage medium may be any tangible medium that contains or stores a program, and the program may be used by or in combination with an instruction execution system, apparatus or device. In one or more embodiments of the present disclosure, a computer-readable signal medium may include a data signal propagated in a baseband or as a part of a carrier wave, and computer-readable program codes are carried in the data signal. The data signal propagated in this way may adopt various forms, including but not limited to, an electromagnetic signal, an optical signal, or any suitable combination of the above. The computer-readable signal medium may also be any computer-readable medium other than the computer-readable storage medium, and the computer-readable signal medium may send, propagate or transmit a program used by or in combination with an instruction execution system, apparatus or device. The program codes contained on the computer-readable medium may be transmitted by any suitable medium, including but not limited to: a wire, an optical cable, RF (radio frequency), etc., or any suitable combination of the above.

The computer-readable medium may be contained in the electronic device or exist alone without being assembled into the electronic device.

The computer-readable medium carries one or more programs, and when the one or more programs are executed by the electronic device, the electronic device is caused to execute the method shown in the above embodiments.

The computer program codes for performing the operations of one or more embodiments of the present disclosure may be written in one or more program design languages or a combination thereof, where the program design languages include object-oriented program design languages such as Java, Smalltalk, C++, and also include conventional procedural program design languages such as “C” language or similar program design languages. The program codes may be executed entirely on a user computer, partly executed on a user computer, executed as an independent software package, partly executed on a user computer and partly executed on a remote computer, or entirely executed on a remote computer or a server. In the case of involving a remote computer, the remote computer may be connected to a user computer through any kind of network, including a local area network (LAN) or a wide area network (WAN), or may be connected to an external computer (for example, connected through the Internet using an Internet service provider).

The flowcharts and block diagrams in the drawings illustrate the possibly implemented architectures, functions and operations of the system, the method and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in one or more embodiments of the present disclosure may be implemented by software or hardware. The name of a unit does not constitute a limitation on the unit itself under certain circumstances, for example, a first acquiring unit may also be described as “a unit for acquiring at least two internet protocol addresses”.

The functions described above herein may be at least partially performed by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the present embodiment, a first video is acquired, where the first video includes multi-frame images, and the first video is a slow-motion video; the first video is divided into a first video subset and a second video subset by a dividing unit; frame dropping is performed on the first video subset; an effect is applied on the first video subset in which frame dropping is performed, and effect application information of the effect is recorded; the first video subset in which the effect is applied is previewed and displayed; and an asset pack including the second video subset and the effect application information is generated. Since frame dropping is performed in advance on the first video subset for previewing to reduce the number of images on which the effect needs to be applied, the asset pack is produced according to original images for the video subset used to generate the asset pack, and the effect application information is encapsulated in the asset pack, resources required for previewing an effect of applying the effect on the slow-motion video and generating the slow-motion video asset pack in which the effect is applied are reduced at the same time, smooth previewing after the effect is applied to the slow-motion video and production of the slow-motion video asset pack in which the effect is applied may be achieved at the same time. The effect application information in the asset pack is used for displaying the slow-motion video in which the effect is applied when a video file is subsequently opened.

According to one or more embodiments of the present disclosure, an image data processing method is provided, including:
acquiring a first video, where the first video includes multi-frame images, and the first video is a slow-motion video;
dividing the first video into a first video subset and a second video subset;
performing frame dropping on the first video subset;
applying an effect on the first video subset in which the frame dropping is performed, and recording effect application information of the effect;
previewing and displaying the first video subset in which the effect is applied; and
generating an asset pack including the second video subset and the effect application information.

According to one or more embodiments of the present disclosure, the performing frame dropping on the first video subset includes:
determining a frame dropping strategy according to a preview display frame rate and an image acquisition frame rate corresponding to the first video; and
performing the frame dropping on the first video subset according to the frame dropping strategy.

According to one or more embodiments of the present disclosure, the generating an asset pack including the second video subset and the effect application information includes:
performing compression encoding on the second video subset to generate the asset pack including a compression-encoded second video subset.

According to one or more embodiments of the present disclosure, the asset pack is further encapsulated with:
speed change information corresponding to the first video.

According to one or more embodiments of the present disclosure, the applying an effect on the first video subset in which the frame dropping is performed includes:
according to a preset effect application strategy for applying a plurality of effects, applying a corresponding one of effects on each of the images in the first video subset in which the frame dropping is performed, where effects applied on the images are the same or different according to the preset effect application strategy.

According to one or more embodiments of the present disclosure, the method further includes: decoding the asset pack to obtain the second video subset in response to a loading instruction of the asset pack;
applying effects on multi-frame images in the decoded second video subset respectively according to the effect application information encapsulated in the asset pack; and
displaying the multi-frame images in which the effects are applied.

According to one or more embodiments of the present disclosure, the effect application information includes a preset effect application strategy of applying the same effect or different effects on the multi-frame images.

According to one or more embodiments of the present disclosure, the displaying the multi-frame images in which the effects are applied includes:
displaying the multi-frame images according to a display frame rate corresponding to speed change information encapsulated in the asset pack.

According to one or more embodiments of the present disclosure, an image data processing apparatus is provided, including:
an acquiring unit, configured to acquire a first video, where the first video includes multi-frame images, and the first video is a slow-motion video;
a dividing unit, configured to divide the first video into a first video subset and a second video subset;
a frame dropping unit, configured to perform frame dropping on the first video subset;
an effect applying unit, configured to apply an effect on the first video subset in which the frame dropping is performed, and record effect application information of the effect;
a displaying unit, configured to preview and display the first video subset in which the effect is applied; and
a generating unit, configured to generate an asset pack including the second video subset and the effect application information.

According to one or more embodiments of the present disclosure, the frame dropping unit is further configured to:
determine a frame dropping strategy according to a preview display frame rate and an image acquisition frame rate corresponding to the first video; and
perform the frame dropping on the first video subset according to the frame dropping strategy.

According to one or more embodiments of the present disclosure, the generating unit is further configured to:
perform compression encoding on the second video subset to generate the asset pack including a compression-encoded second video subset.

According to one or more embodiments of the present disclosure, the asset pack is further encapsulated with: speed change information corresponding to the first video.

According to one or more embodiments of the present disclosure, the effect applying unit is further configured to: according to a preset effect application strategy for applying a plurality of effects, apply a corresponding one of effects on each of the images in the first video subset in which the frame dropping is performed, where effects applied on the images are the same or different according to the preset effect application strategy.

According to one or more embodiments of the present disclosure, the device further includes a second displaying unit, and the second displaying unit is configured to:
decode the asset pack to obtain the second video subset in response to a loading instruction of the asset pack;
apply effects on multi-frame images in the decoded second video subset respectively according to the effect application information encapsulated in the asset pack; and
display the multi-frame images in which the effects are applied.

According to one or more embodiments of the present disclosure, the effect application information includes a preset effect application strategy of applying the same effect or different effects on the multiple frames of video images.

According to one or more embodiments of the present disclosure, the first displaying unit is further configured to:
display the multi-frame images according to a display frame rate corresponding to speed change information encapsulated in the asset pack.

According to one or more embodiments of the present disclosure, an electronic device is provided, including:
at least one processor and
at least one memory configured to store computer instructions executable by the at least one processor;
wherein the computer instructions, when executed by the at least one processor, causes the at least one processor to perform the image data processing method according to the one or more embodiments of the present disclosure.

According to one or more embodiments of the present disclosure, a non-transitory computer-readable storage medium is provided, where the computer-readable storage medium is stored with computer instructions, and the computer instructions, when executed by at least a processor, cause the processor to perform the image data processing method according to the one or more embodiments of the present disclosure.

According to one or more embodiments of the present disclosure, a computer program product is provided, including a computer program, where the computer program product, when executed by a computer, causes the computer to implement the image data processing method according to the one or more embodiments of the present disclosure.

The above description is only one or more embodiments of the present disclosure and an explanation of applied technical principles. Those skilled in the art should understand that the scope of disclosure involved in the present disclosure is not limited to the technical solutions formed by the specific combination of the above technical features, but also covers other technical solutions formed by the arbitrary combination of the above technical features or their equivalent features without departing from the above disclosure concept. For example, the above features and technical features having similar functions as the above features disclosed in the present disclosure (but not limited to) are mutually replaced to form a technical solution.

In addition, although the operations are depicted in a specific order, this should not be understood as requiring the operations to be performed in the specific order shown or in a sequential order. Under certain circumstances, multitasking and parallel processing may be advantageous. Similarly, although the above discussion contains several specific implementation details, these should not be interpreted as limiting the scope of the present disclosure. Certain features described in the context of separate embodiments may also be implemented in a single embodiment in combination. On the other hand, various features described in the context of a single embodiment may also be implemented in multiple embodiments individually or in any suitable sub-combination.

Although the subject matter has been described in a language specific to structural features and/or method logical actions, it should be understood that the subject matter defined in the appended claims is not necessarily limited to the specific features or actions described above. On the contrary, the specific features and actions described above are only exemplary forms of implementing the claims.

1. An image data processing method, comprising:
acquiring a first video, wherein the first video comprises multi-frame images, and the first video is a slow-motion video;
dividing the first video into a first video subset and a second video subset;
performing frame dropping on the first video subset;
applying an effect on the first video subset in which the frame dropping is performed, and recording effect application information of the effect;
previewing and displaying the first video subset in which the effect is applied; and
generating an asset pack comprising the second video subset and the effect application information.

2. The method of claim 1, wherein the performing frame dropping on the first video subset comprises:
determining a frame dropping strategy according to a preview display frame rate and an image acquisition frame rate corresponding to the first video; and
performing the frame dropping on the first video subset according to the frame dropping strategy.

3. The method of claim 1, wherein the generating an asset pack comprising the second video subset and the effect application information comprises:
performing compression encoding on the second video subset to generate the asset pack comprising a compression-encoded second video subset.

4. The method of claim 1, wherein the asset pack is further encapsulated with:
speed change information corresponding to the first video.

5. The method of claim 1, wherein the applying an effect on the first video subset in which the frame dropping is performed comprises:
according to a preset effect application strategy for applying a plurality of effects, applying a corresponding one of the effects on each of the images in the first video subset in which the frame dropping is performed, wherein the effects applied on the images are same or different according to the preset effect application strategy.

6. The method of claim 1, wherein the method further comprises:
decoding the asset pack to obtain the second video subset in response to a loading instruction of the asset pack;
applying effects on multi-frame images in a decoded second video subset respectively according to the effect application information encapsulated in the asset pack; and
displaying the multi-frame images in which the effects are applied.

7. The method of claim 6, wherein the effect application information comprises a preset effect application strategy of applying a same effect or different effects on the multi-frame images.

8. The method of claim 6, wherein the displaying the multi-frame images in which the effects are applied comprises:
displaying the multi-frame images according to a display frame rate corresponding to speed change information encapsulated in the asset pack.

9. An electronic device, comprising:
at least one processor; and
at least one memory configured to store computer instructions executable by the at least one processor,
wherein the computer instructions, when executed by the at least one processor, cause the at least one processor to perform an image data processing method, which comprises:
acquiring a first video, wherein the first video comprises multi-frame images, and the first video is a slow-motion video;
dividing the first video into a first video subset and a second video subset;
performing frame dropping on the first video subset;
applying an effect on the first video subset in which the frame dropping is performed, and recording effect application information of the effect;
previewing and displaying the first video subset in which the effect is applied; and
generating an asset pack comprising the second video subset and the effect application information.

10. The electronic device of claim 9, wherein the performing frame dropping on the first video subset comprises:
determining a frame dropping strategy according to a preview display frame rate and an image acquisition frame rate corresponding to the first video; and
performing the frame dropping on the first video subset according to the frame dropping strategy.

11. The electronic device of claim 9, wherein the generating an asset pack comprising the second video subset and the effect application information comprises:
performing compression encoding on the second video subset to generate the asset pack comprising a compression-encoded second video subset.

12. The electronic device of claim 9, wherein the asset pack is further encapsulated with:
speed change information corresponding to the first video.

13. The electronic device of claim 9, wherein the applying an effect on the first video subset in which the frame dropping is performed comprises:
according to a preset effect application strategy for applying a plurality of effects, applying a corresponding one of the effects on each of the images in the first video subset in which the frame dropping is performed, wherein the effects applied on the images are same or different according to the preset effect application strategy.

14. The electronic device of claim 9, wherein the at least one processor is caused to further perform:
decoding the asset pack to obtain the second video subset in response to a loading instruction of the asset pack;
applying effects on multi-frame images in a decoded second video subset respectively according to the effect application information encapsulated in the asset pack; and
displaying the multi-frame images in which the effects are applied.

15. The electronic device of claim 14, wherein the effect application information comprises a preset effect application strategy of applying a same effect or different effects on the multi-frame images.

16. The electronic device of claim 14, wherein the displaying the multi-frame images in which the effects are applied comprises:
displaying the multi-frame images according to a display frame rate corresponding to speed change information encapsulated in the asset pack.

17. A non-transitory computer-readable storage medium, wherein the computer-readable storage medium is stored with computer instructions, and the computer instructions, when executed by at least a processor, cause the processor to perform an image data processing method, which comprises:
acquiring a first video, wherein the first video comprises multi-frame images, and the first video is a slow-motion video;
dividing the first video into a first video subset and a second video subset;
performing frame dropping on the first video subset;
applying an effect on the first video subset in which the frame dropping is performed, and recording effect application information of the effect;
previewing and displaying the first video subset in which the effect is applied; and
generating an asset pack comprising the second video subset and the effect application information.

18. The storage medium of claim 17, wherein the performing frame dropping on the first video subset comprises:
determining a frame dropping strategy according to a preview display frame rate and an image acquisition frame rate corresponding to the first video; and
performing the frame dropping on the first video subset according to the frame dropping strategy.

19. The storage medium of claim 17, wherein the generating an asset pack comprising the second video subset and the effect application information comprises:
performing compression encoding on the second video subset to generate the asset pack comprising a compression-encoded second video subset.

20. The storage medium of claim 17, wherein the asset pack is further encapsulated with:
speed change information corresponding to the first video.
